(19) United States
(12) Patent Application Publication
(10) Pub. No.: US 2011/0318443 A1
(43) Pub. Date: Dec. 29, 2011

(54) PLACING AND REMOVING DEVICE FOR INSERT MOLDED ARTICLE

(75) Inventor: YU-WANG ZHOU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/916,612

(22) Filed: Oct. 31, 2010

(30) Foreign Application Priority Data
Jun. 24, 2010 (CN) 201010208609.X

(51) Int. Cl. B29C 31/08

(52) U.S. Cl. 425/126.1

(57) ABSTRACT

A device for removing an insert molded article and simultaneously placing a preformed item, includes a bracket; a removing mechanism slidably mounted to the bracket, the removing mechanism comprises a suck for sucking the insert molded article; a placing mechanism slidably mounted to the bracket, the placing mechanism comprises a holding base for holding the preformed item; a first driving element mounted to the bracket and connected to the removing mechanism to drive the removing mechanism to slide relative to the bracket; and a second driving element mounted to the bracket and connected to the placing mechanism to drive the placing mechanism to slide relative to the bracket.

### BACKGROUND

1. Technical Field

This disclosure relates to placing and removing devices and, particularly, to a placing and removing device for use with insert molded articles.

2. Description of Related Art

A typical method for incorporating preformed items with a molded article is insert molding. Insert molding involves a first step of placing the preformed item into a desired location within a mold, and a second step of adding a molten moldable material, such as polymer, into the mold in such a manner that the polymer contacts or surrounds at least part of the preformed item. As the moldable material is cured by cooling, the preformed item is incorporated into the molded article. And the last step of the insert molding is ejecting the molded article out of the mold. Thus, in a typical insert molding method, the step of ejecting a molded article and the step of replacing it with a preformed item not yet molded must be performed sequentially, that is the typical insert molding method is complicated.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary placing and removing device for insert molded articles. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a placing and removing device for insert molded articles.

FIG. 2 is another exploded view of the placing and removing device shown in FIG. 1, viewed from a different perspective.

FIG. 3 is an assembled view of the placing and removing device in FIG. 1.

FIG. 4 is a planar view of the placing and removing device shown in FIG. 3.

### DETAILED DESCRIPTION

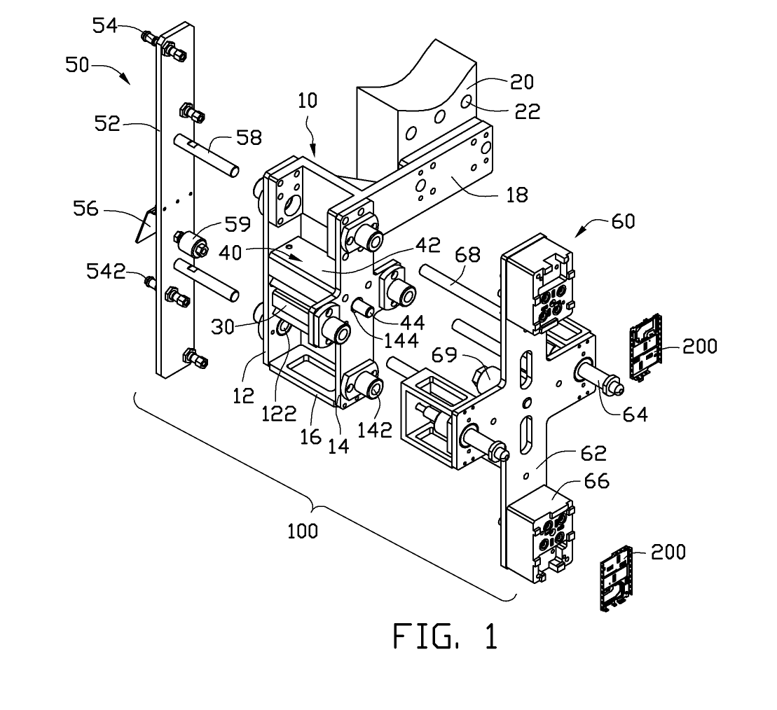

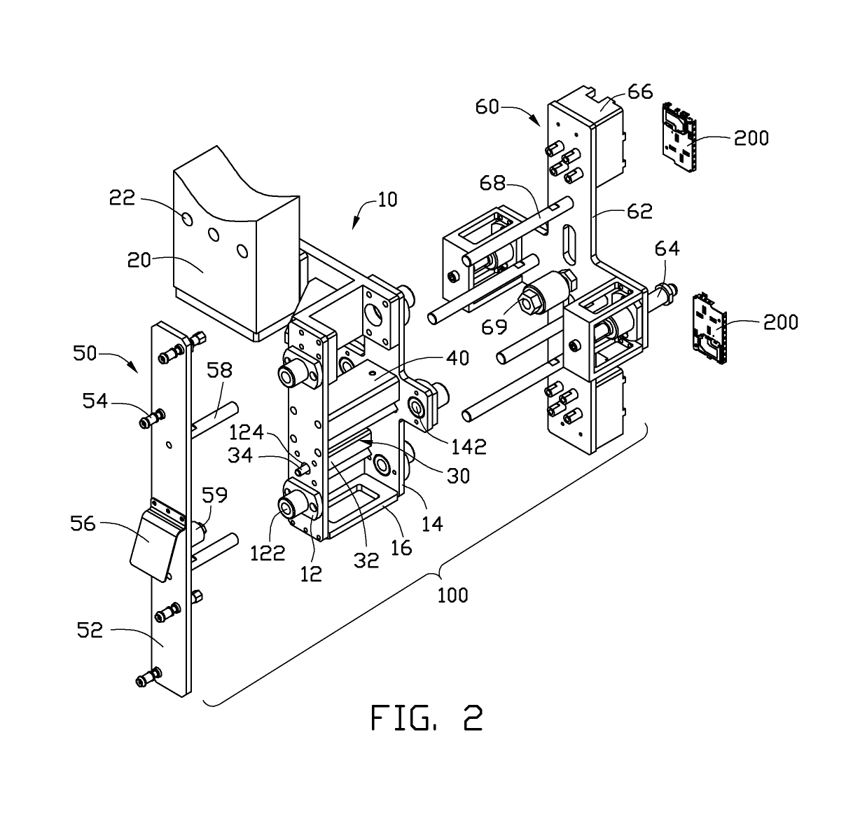

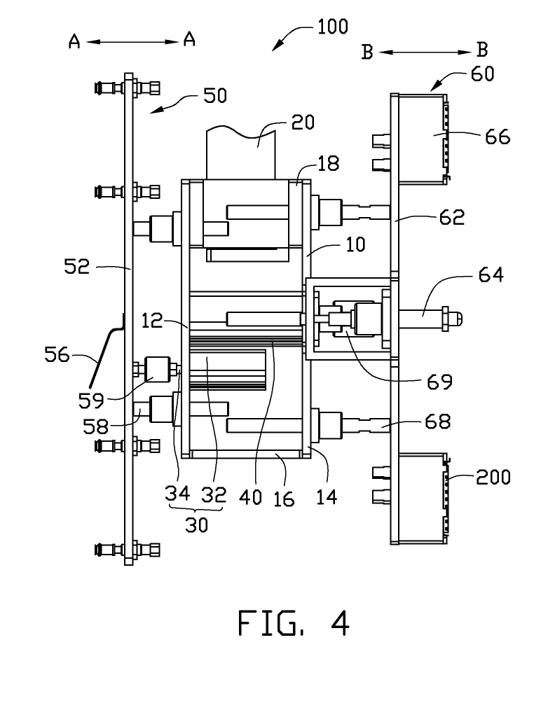

Referring to FIGS. 1-2, an exemplary placing and removing device 100 for insert molded articles, includes a bracket 10, a mount 20, a first driving element 30, a second driving element 40, a removing mechanism 50, and a placing mechanism 60. The bracket 10 is connected to the mount 20, the first driving element 30 and the second driving element 40 are both mounted to the bracket 10. The mount 20 may define a number of mounting holes 22 for mounting the bracket 10 to a robot of a molding machine (not shown). The removing mechanism 50 is connected to the first driving element 30, and the first driving element 30 drives the removing mechanism 50 to linearly move towards and away from the bracket 10 (see arrow A-A of FIG. 4) to remove insert molded articles (not shown) from a first mold (not shown) as will be described in more detail below. The placing mechanism 60 connects to the second driving element 40, and the second driving element 40 drives the placing mechanism 60 to linearly move towards and away from the bracket 10 (see arrow B-B of FIG. 4) to place preformed items 200 into a second mold (not shown) as will be described in more detail below. The first mold and the second mold can be closed to form a molding cavity for molding one insert molded article. And when the first mold and the second mold are separated again, the molding insert article remains in the first mold and can be removed by the first driving element 30 and the removing mechanism 50, and one preformed item can simultaneously be placed in the second mold by the second driving element 40 and the placing mechanism 60.

The bracket 10 includes a first mounting plate 12, a second mounting plate 14 spaced apart from (e.g., parallel to) the first mounting plate 12, one or more connecting plates 16 connecting the first mounting plate 12 to the second mounting plate 14, and a retaining plate 18 connecting the second mounting plate 14 to the mount 20. The first mounting plate 12 defines one or more first guiding holes 122 for guiding the removing mechanism 50 to move relative to the bracket 10. The second mounting plate 14 defines one or more second guiding holes 142 for guiding the placing mechanism 60 to move relative to the bracket 10.

The first driving element 30 includes a retaining portion 32 and a sliding portion 34 slidably mounted to the retaining portion 32. The retaining portion 32 is mounted to the first mounting plate 12. The sliding portion 34 passes through a first opening 124 defined in the first mounting plate 12 and connects to the removing mechanism 50 so the removing mechanism 50 can move together with the sliding portion 34. The second driving element 40 includes a fixed portion 42 and a movable portion 44 slidably mounted to the fixed portion 42. The fixed portion 42 is mounted to the second mounting plate 14. The movable portion 44 passes through a second opening 144 defined in the second mounting plate 14 and connects to the placing mechanism 60 so the placing mechanism 60 can move together with the movable portion 44. In the exemplary embodiment, the first driving element 30 and the second driving element 40 may be piston/cylinder devices. The retaining portion 32 and the fixed portion 42 are respectively chambers of the cylinders, and the sliding portion 34 and the movable portion 44 are respectively pistons of the cylinders.

The removing mechanism 50 includes a board 52, one or more suction devices 54 for using vacuum from a source (not shown) to grasp the insert molded articles in a mold, a buffer 56, two guiding bar 58, and a linkage 59. The suction devices 54 and the buffer 56 are mounted to one surface of the board 52 facing away from the bracket 10. The guiding bar 58 and the linkage 59 are mounted to another surface of the board 52 opposite to the suction devices 54 and the buffer 56. The buffer 56 is a resilient bent plate located between the suction devices 54 to prevent the board 52 from pressing against and damaging the insert molded articles. Each guiding bar 58 extends through and slides in one of the first guiding holes 122. When the removing mechanism 50 slides relative to the bracket 10, the guiding bars 58 slide in the first guiding holes 122. The linkage 59 is coupled between the sliding portion 34 and the board 52 to connect the first driving element 30 to the removing mechanism 50 so the sliding portion 34 slides relative to the retaining portion 32, and the sliding portion 34 drives the removing mechanism 50 to move relative to the bracket 10.

The placing mechanism 60 includes a main body 62, two positioning posts 64, two holding bases 66, four guiding rods 68, and a connecting member 69. The positioning posts 64 and the holding bases 66 are mounted to a surface of the main body 62 facing away from the bracket 10. The guiding rods 68 and the connecting member 69 are mounted to another surface of the main body 62 facing toward the bracket 10. The positioning posts 64 are used to align the placing mechanism 60 with the second mold. The holding bases 66 are for holding the preformed items 200 on the placing mechanism 60. Each guiding rod 68 extends through one of the second guiding holes 142. When the placing mechanism 60 slides relative to the bracket 10, the guiding rods 68 slide in the second guiding holes 142. The connecting member 69 is coupled between the movable portion 44 and the main body 62 to connect the second driving element 40 to the placing mechanism 60 so when the movable portion 44 slides relative to the fixed portion 42, the movable portion 44 drives the placing mechanism 60 to move relative to the bracket 10.

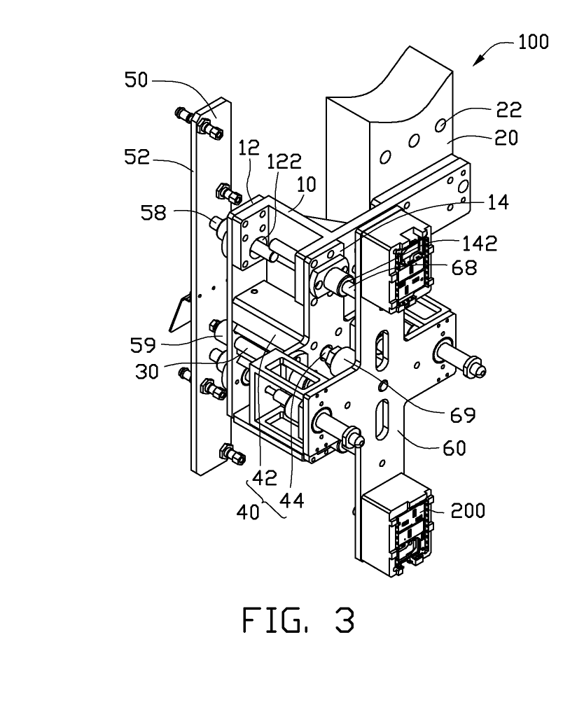

Referring to FIGS. 3 and 4, in assembly, the retaining portion 32 is mounted to the first mounting plate 12 with the sliding portion 34 extending through the first opening 124. The fixed portion 42 is mounted to the second mounting plate 14 with the movable portion 44 extending through the second opening 144. The connecting plates 16 are coupled between the first mounting plate 12 and the second mounting plate 14. The retaining plate 18 is coupled between the second mounting plate 14 and the mount 20. The guiding bars 58 are inserted into the first guiding holes 122 with the linkage 59 retained to the sliding portion 34. The guiding rods 68 are inserted into the second guiding holes 142 with the connecting member 69 retained to the movable portion 44.

Referring to FIGS. 3 and 4, in use, the first driving element 30 and the second driving element 40 are simultaneously started. And then, the sliding portion 34 slides relative to the retaining portion 32 to drive the removing mechanism 50 to move toward the first mold along the guiding bars 58, until the suction devices 54 grasp the insert molded article. Simultaneously, the movable portion 44 slides relative to the fixed portion 42 to drive the placing mechanism 60 to move toward the second mold along the guiding rods 68, until the preformed item 200 is inserted in the second mold.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A device for removing an insert molded article and placing a preformed item, the device comprising:
a bracket;
a removing mechanism slidably mounted to the bracket, the removing mechanism including a suck for sucking up the insert molded article;
a placing mechanism slidably mounted to the bracket, the placing mechanism including a holding base for holding the preformed item;
a first driving element mounted to the bracket and connected to the removing mechanism to drive the removing mechanism to slide relative to the bracket; and
a second driving element mounted to the bracket and connected to the placing mechanism to drive the placing mechanism to slide relative to the bracket.

2. The device of claim 1, further comprising a mount mounted to the bracket, for driving the bracket to move.

3. The device of claim 1, wherein the bracket comprises a first mounting plate, a second mounting plate spaced apart from the first mounting plate and a connecting plate connecting the first mounting plate and the second mounting plate; the removing mechanism is slidably mounted to the first mounting plate, the placing mechanism is slidably mounted to the second mounting plate.

4. The device of claim 3, wherein the first mounting plate defines a first guiding hole; the removing mechanism comprises a guiding bar slidably inserted in the first guiding hole.

5. The device of claim 4, wherein the first driving element comprises a retaining portion and a sliding portion slidably mounted to the retaining portion; the retaining portion is retained to the first mounting plate and the sliding portion is retained to the removing mechanism.

6. The device of claim 5, wherein the removing mechanism comprises a linkage, the linkage is coupled between the sliding portion and the first driving element to connect the first driving element to the removing mechanism.

7. The device of claim 3, wherein the second mounting plate defines a second guiding hole; the placing mechanism comprises a guiding rod slidably inserted in the second guiding hole; when the placing mechanism slides relative to the bracket, the guiding rod slides in the second guiding hole.

8. The device of claim 7, wherein the second driving element comprises a fixed portion and a movable portion slidably mounted to the fixed portion; the fixed portion is retained to the second mounting plate and the movable portion is retained to the placing mechanism.

9. The device of claim 8, wherein the placing mechanism comprises a connecting member retained to the movable portion.

10. The device of claim 1, wherein the removing mechanism has a buffer mounted on a surface thereof facing away from the bracket, the buffer is used for preventing the insert molded article from pressing and damaging.

11. A device for removing an insert molded article and simultaneously placing a preformed item, the device comprising:
a bracket;
a removing mechanism slidably mounted to the bracket, the removing mechanism including a suck for sucking the insert molded article;
a placing mechanism slidably mounted to the bracket opposite to the removing mechanism, the placing mechanism including a holding base for holding the preformed item;
a first driving element mounted to the bracket and connected to the removing mechanisme; and
a second driving element mounted to the bracket and connected to the placing mechanism;
wherein when the first driving element drives the removing mechanism to slide relative to the bracket, the second driving element simultaneously drives the placing mechanism to slide relative to the bracket.

12. The device of claim 11, further comprises a mount mounted to the bracket, the mount being for driving the bracket to move.

13. The device of claim 11, wherein the bracket comprises a first mounting plate, a second mounting plate spaced apart from the first mounting plate and a connecting plate connecting the first mounting plate and the second mounting plate; the removing mechanism slidably mounted to the first mounting plate, the placing mechanism slidably mounted to the second mounting plate.

14. The device of claim 13, wherein the first mounting plate defines a first guiding hole; the removing mechanism including a guiding bar slidably inserted in the firs guiding hole.

15. The device of claim 14, wherein the first driving element comprises a retaining portion and a sliding portion slidably mounted to the retaining portion; the retaining portion is retained to the first mounting plate and the sliding portion is retained to the removing mechanism.

16. The device of claim 15, wherein the removing mechanism comprises a linkage, the linkage is coupled between the sliding portion and the first driving element to connect the first driving element to the removing mechanism.

17. The device of claim 13, wherein the second mounting plate defines a second guiding hole; the placing mechanism comprises a guiding rod slidably inserted in the second guiding hole; when the placing mechanism slides relative to the bracket, the guiding rod slides in the second guiding hole.

18. The device of claim 17, wherein the second driving element comprises a fixed portion and a movable portion slidably mounted to the fixed portion; the fixed portion is retained to the second mounting plate and the movable portion is retained to the placing mechanism.

19. The device of claim 18, wherein the placing mechanism comprises a connecting member retained to the movable portion.

20. The device claim 10, wherein the removing mechanism has a buffer mounted one surface thereof facing away from the bracket, the buffer is for prevent the insert molded article from pressing and damaging.
